(19) United States
(12) Patent Application Publication
(10) Pub. No.: US 2021/0330524 A1
(43) Pub. Date: Oct. 28, 2021

(54) Transport Apparatus for a Weak Person

(71) Applicant: Kevin Chih-Yu Chien, Coquitlam (CA)

(72) Inventor: Kevin Chih-Yu Chien, Coquitlam (CA)

(21) Appl. No.: 16/858,885

(22) Filed: Apr. 27, 2020

(51) Int. Cl. A61G 5/14; A61G 5/02; A61G 5/04; A61G 5/06; A61G 5/12; A61G 5/10

(52) U.S. Cl. CPC A61G 5/14; A61G 5/02; A61G 5/042; A61G 5/068; A61G 2200/52; A61G 5/124; A61G 5/104; A61G 2200/34; A61G 2200/36; A61G 5/125

(57) ABSTRACT

A transport apparatus has a mobile chassis, a lifting mechanism, two armpit supports structured and operated mirror-symmetrical to one another, and two seat assemblies. The lifting mechanism includes a lifting arm for assembling a chest rest and two lifting racks, and a linear actuator driving the lifting arm to pivot upward or downward. The armpit supports are assembled on the lifting racks and transversely extend toward a rear of the mobile chassis. The seat assemblies are assembled on the mobile chassis. Each of the seat assembly has a seat plate driven to rotate by a drive motor to form a seat. The weak person can be moved directly by the transport apparatus with voice command or with a remote control. Since the weak person is not moved by the care workers, the weak person can be moved in an easier and safer way.

### BACKGROUND OF THE INVENTION

### 1. Field of the Invention

The present invention relates to a transport apparatus, especially to a transport apparatus that moves a weak person between a bed, sanitary fixtures and a sofa without the help of the care workers.

### 2. Description of the Prior Art(s)

A conventional transport apparatus for moving a weak person with mobility problems is a wheelchair or a wheeled stretcher. However, it is laborious for care workers to support and move the weak person to or from the wheelchair or the wheeled stretcher, and it is also laborious to push the wheelchair and the wheeled stretcher.

Another conventional way to move a weak person is using a patient lifter having a sling. The sling may be hydraulically or electrically lifted. Before moving the weak person with the patient lifter, the care worker has to carry the weak person in his/her arms and put the weak person in the sling. Then the care worker moves the patient lifter along with the weak person to another place. Afterwards, the care worker has to carry the weak person in his/her arms again to remove the weak person from the sling. Carrying the weak person in the care worker's arms is not only laborious to the care worker but also dangerous to both the care worker and the weak person.

Due to the problem of an aging population, there is an increase in the weak people and a decrease in the care workers. In order to reduce the care workers' burdens, the care workers may have to leave the weak people, with diapers, in bed for a long time and change the diapers regularly, which negatively impacts the weak people's quality of life.

To overcome the shortcomings, the present invention presents a transport apparatus for a weak person to mitigate or obviate the aforementioned problems.

### SUMMARY OF THE INVENTION

The main objective of the present invention is to provide a transport apparatus for a weak person. The transport apparatus has a mobile chassis, a lifting mechanism, two armpit supports, and two seat assemblies.

The lifting mechanism is assembled on a front portion of the mobile chassis, and includes a lifting arm pivotally assembled on the front portion of the mobile chassis, a chest rest mounted on a rear end of the lifting arm, and a linear actuator assembled to the mobile chassis and the lifting arm and driving the chest rest to pivot upward or downward.

The two armpit supports are separately assembled on left and right sides of an upper mounting portion of the lifting arm and are structured and operated mirror-symmetrical to one another. Each armpit support is comprised of at least one bearing seat assembled on the upper mounting portion of the lifting arm and an embracing arm rotatably mounted through the at least one bearing seat and transversely extending toward a rear of the mobile chassis.

The two seat assemblies are mirror-symmetrically assembled on the mobile chassis. Each seat assembly is comprised of a seat plate connected to and driven to rotate by a drive motor to form a seat.

The transport apparatus of the present invention is simple and compact. The weak person can move the transport apparatus directly, or the transport apparatus can be operated by voice command from the weak person or the care workers, or by the remote control which is under the control of the weak person or the care workers. Since the weak person is not moved by the care workers, the weak person can be moved in an easier and safer way.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a transport apparatus for a weak person in accordance with the present invention;

FIG. 2 is a rear perspective view of the transport apparatus in FIG. 1;

FIG. 3 is an operational side view of the transport apparatus in FIG. 1, wherein the transport apparatus is beside a bed, with the weak person in a sitting position on the bed;

FIG. 4, as a continuation of FIG. 3, is an operational side view of the transport apparatus, wherein the transport apparatus has approached the bed, with the weak person ready to be lifted by the transport apparatus;

FIG. 5, as a continuation of FIG. 4, is an operational side view of the transport apparatus, wherein the weak person has been lifted by the transport apparatus;

FIG. 6, as a continuation of FIG. 5, is an operational side view of the transport apparatus, wherein the weak person is lowered to sit on two seat plates of the transport apparatus;

FIG. 7 is a perspective view of a left armpit support of the transport apparatus in FIG. 1;

FIG. 8 is an exploded perspective view of the left armpit support of the transport apparatus in FIG. 7;

FIG. 9 is a perspective view of a right armpit support, which is mirror-symmetrical to FIG. 7;

FIG. 10 is an exploded perspective view of the right armpit support, which is mirror-symmetrical to FIG. 8;

FIG. 11 is a rear view of the transport apparatus in FIG. 1; and

FIG. 12 is an operational rear view of the transport apparatus in FIG. 6, wherein the left armpit support and a right armpit support are rotated to embrace the weak person's back and the two seat plates are driven to form a seat.

### DETAILED DESCRIPTION OF THE PREFERRED EMBODIMENTS

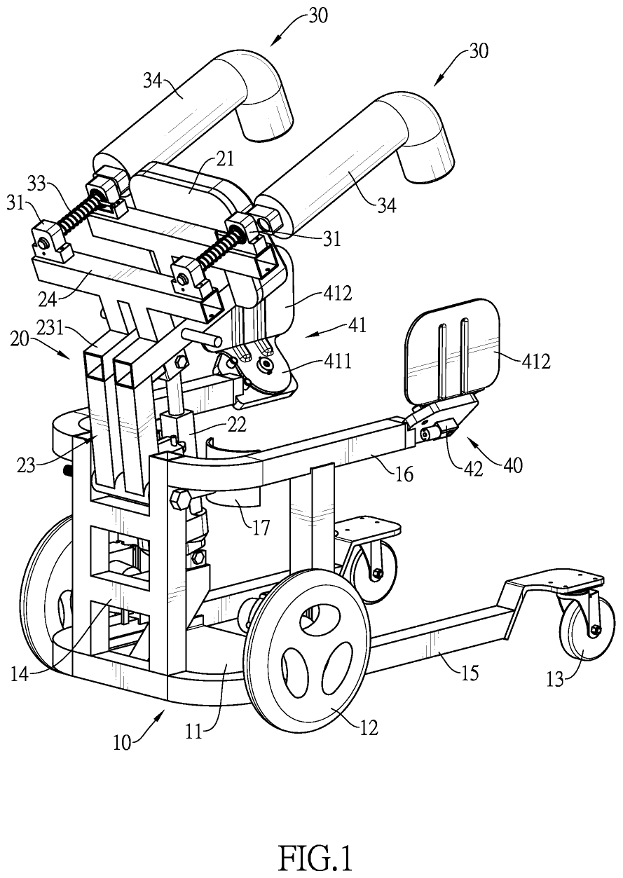

With reference to FIGS. 1 to 3, a transport apparatus in accordance with the present invention is for transporting a weak person 51, such as an old person, or a person with mobility problem, or a physically disabled person from or to a bed 52, a sofa or sanitary fixtures. The transport apparatus is comprised of a mobile chassis 10, a lifting mechanism 20, two armpit supports 30A, 30B, and two seat assemblies 40.

The mobile chassis 10 is comprised of a deck 11 for the weak person 51 to step and stand thereon. Two motorized wheels 12 are assembled on a front portion of the mobile chassis 10 and are located on left and right sides of the mobile chassis 10 respectively. Multiple supporting wheels 13 are assembled on a rear portion of the mobile chassis 10. Each of the supporting wheels 13 may be, but is not limited to, a swivel caster wheel. The rear portion of the mobile chassis 10 along with the supporting wheels 13 can run into a space between the floor and the bed 52 or run on two sides of a toilet bowl.

In the preferred embodiment of the present invention as shown in FIG. 1, the mobile chassis 10 is further comprised of a front upright frame 14, two lower extending bars 15, two upper extending bars 16, and two knee supports 17.

The front upright frame 14 is located on and protrudes up from the deck 11. The front upright frame 14 and the deck 11 are formed as the front portion of the mobile chassis 10. The motorized wheels 12 are assembled on left and right sides of the front portion of the mobile chassis 10.

The lower extending bars 15 transversely extend from the front upright frame 14 toward a rear of the mobile chassis 10 and are located on the left and right sides of the mobile chassis 10 respectively. Each of the lower extending bars 15 has a distal end. The distal ends of the two lower extending bars 15 are formed as the rear portion of the mobile chassis 10. The supporting wheels 13 are assembled on the distal ends of the lower extending bars 15. The upper extending bars 16 transversely extend from the front upright frame 14 toward the rear of the mobile chassis 10, and are located on the left and right sides of the mobile chassis 10 respectively and above the lower extending bars 15 respectively. Each of the upper extending bars 16 has a distal end.

The knee supports 17 are separately assembled on the front upright frame 14 and are located between the two upper extending bars 16. The knee supports 17 provide support for the knees of the weak person 51 when the weak person 51 is in the process of being raised or lowered by the lifting mechanism 20 of the transport apparatus.

The lifting mechanism 20 is assembled on the front portion of the mobile chassis 10 and is comprised of a lifting arm 23, two lifting rack 24, a chest rest 21 and a linear actuator 22. The lifting arm 23 is pivotally assembled on the front portion of the mobile chassis 10, and more specifically, is pivotally assembled on the front upright frame 14. The lifting arm 23 has an upper mounting portion 231 and a rear end. The rear end of the lifting arm 23 faces toward the rear of the mobile chassis 10. The lifting racks 24 are separately assembled on the upper mounting portion 231 of the lifting arm 23. The chest rest 21 is mounted on the rear end of the lifting arm 23. The linear actuator 22 is assembled to the deck 11 of the mobile chassis 10 and the lifting arm 23, and drives the lifting arm 23 and the chest rest 21 to pivot upward or downward. Specifically, the linear actuator 22 may be hydraulic or electric.

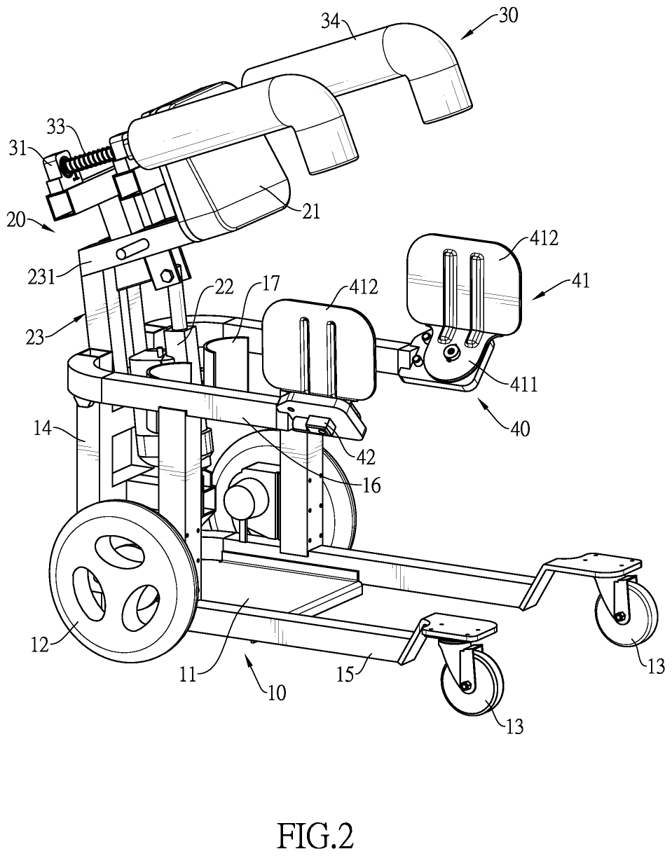

With reference to FIGS. 1 and 2, the two armpit supports 30A, 30B are separately assembled on the lifting racks 24. The two armpit supports 30A, 30B includes one left armpit support 30A assembled on a left side of the lifting racks 24, and one right armpit support 30B assembled on a right side of the lifting racks 24. A distance between the two armpit supports 30A, 30B fits the chest width of an average person, such that when the transport apparatus approaches the weak person 51, the two armpit supports 30A, 30B extend through two armpits of the weak person 51.

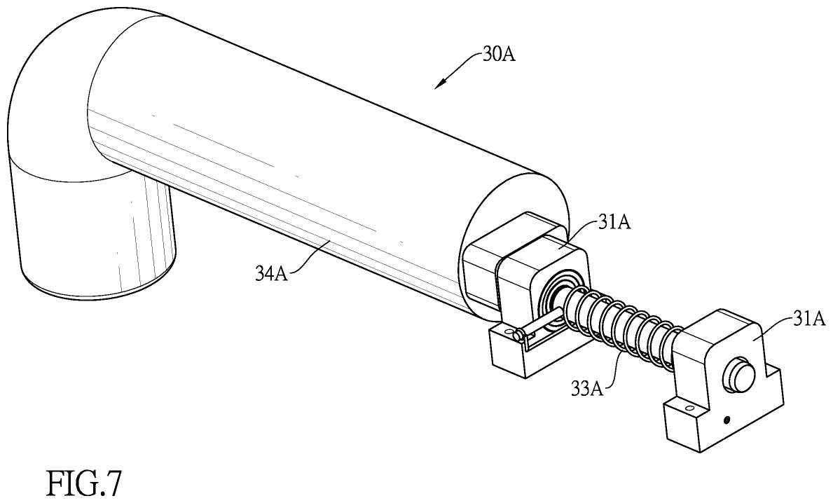

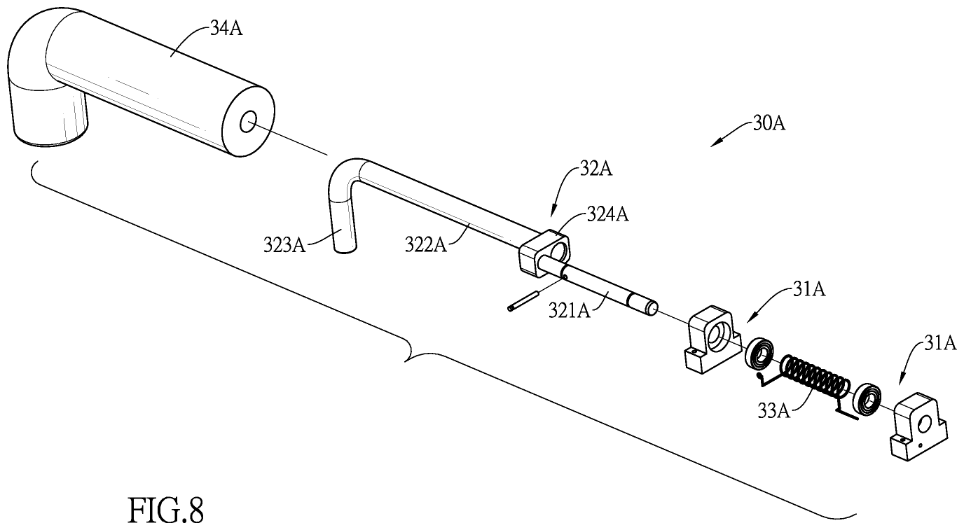

With further reference to FIGS. 7 and 8, the left armpit support 30A is comprised of at least one bearing seat 31A and an embracing arm 32A. The at least one bearing seat 31A is assembled on at least one of the lifting racks 24. The embracing arm 32A is mounted through the at least one bearing seat 31A, is rotatable, transversely extends toward the rear of the mobile chassis 10. The embracing arm 32A is combined as a solid unit and is comprised of a front shaft 321A, a connecting block 324A and a rear shaft 322A. The front shaft 321A is rotatably mounted through the at least one bearing seat 31A. A front end of the rear shaft 322A is connected solidly with a rear end of the front shaft 321A through the connecting block 324A. The rear shaft 322A extends parallel to the front shaft 321A and toward a rear of the transport apparatus, is on a left side of the front shaft 321A, and is non-coaxial with the front shaft 321A. A rear end portion 323A of the rear shaft 322A is bent and selectively extends downward toward the mobile chassis 10.

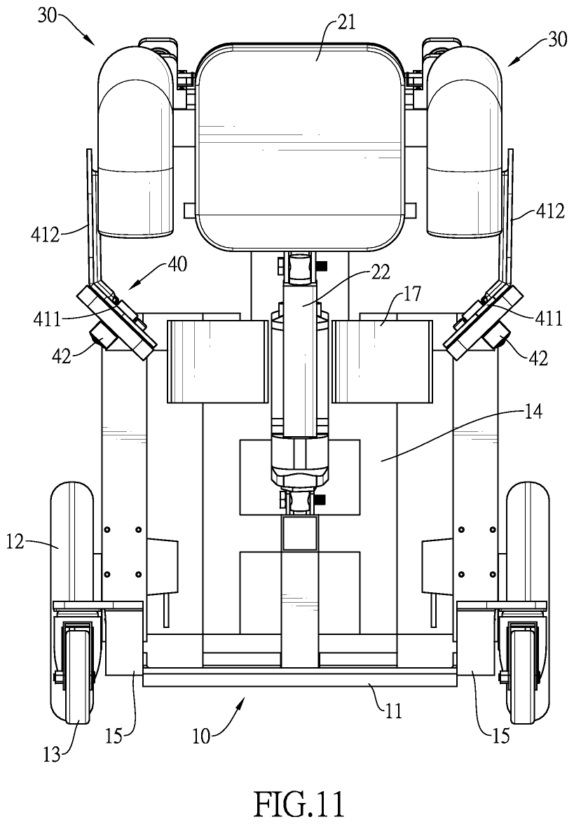

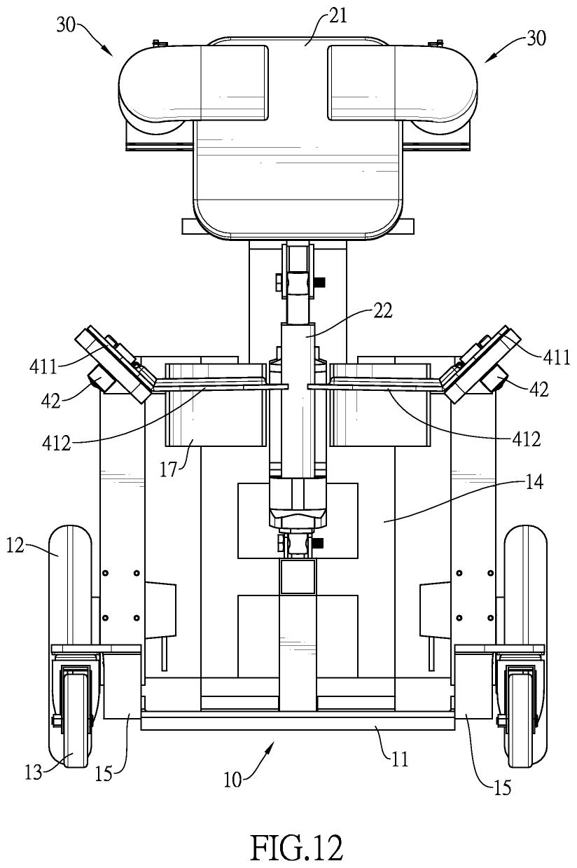

A resilient element 33A is connected to the front shaft 321A and the upper mounting portion 231 of the lifting arm 23. In the preferred embodiment, the resilient element 33A is a spring, particularly a torsion spring, and is connected to the front shaft 321A and one of the at least one bearing seat 31A that is installed on the upper mounting portion 231 of the lifting arm 23. With reference to FIG. 11, the rear end portion 323A of the rear shaft 322A extends downward toward the mobile chassis 10 in a natural state. With further reference to FIG. 12, when the embracing arm 32A is forced to rotate by the weight of the weak person to allow the rear end portion 323A of the rear shaft 322A to extend inward toward the right side of the transport apparatus, the resilient element 33A tends to rotate the embracing arm 32A reversely to allow the rear end portion 323A of the rear shaft to extend downward toward the mobile chassis.

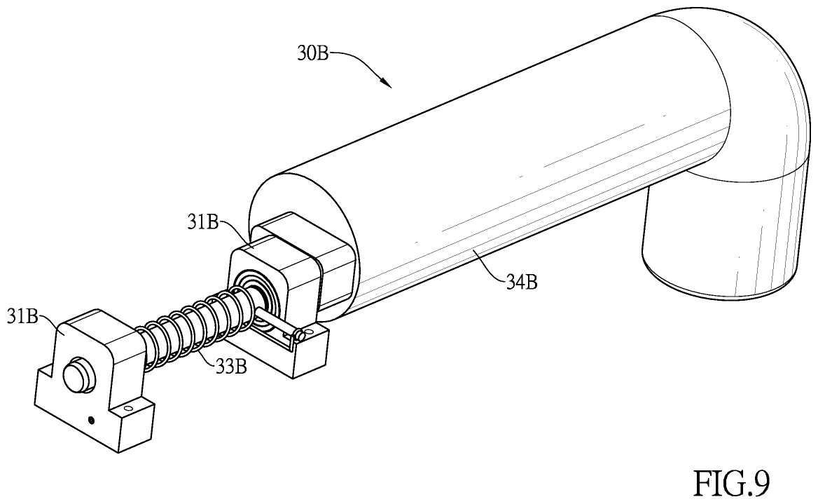

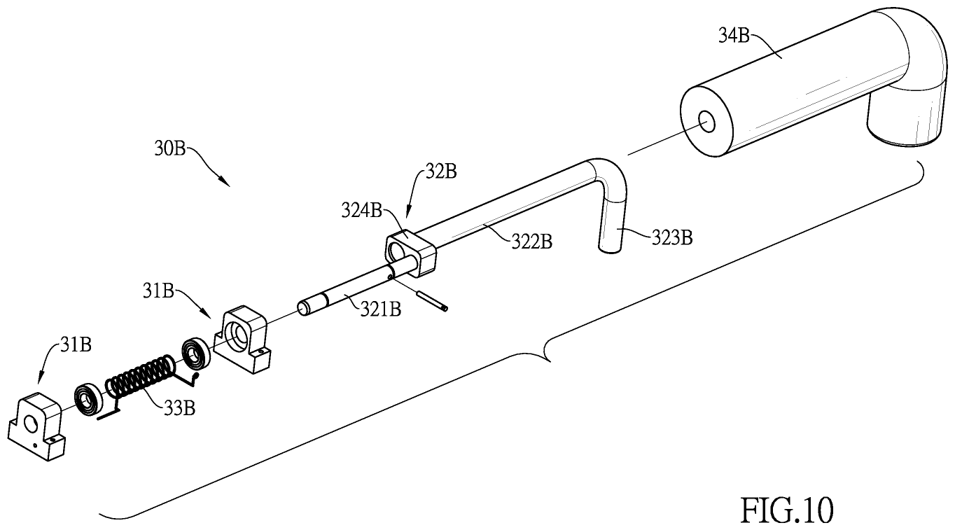

With reference to FIGS. 9 and 10, the right armpit support 30B is mirror-symmetrical in structure to the left armpit support 30A shown in FIGS. 7 and 8. For the right armpit support 30B, the rear shaft 322B extends parallel to the front shaft 321B toward the rear of the transport apparatus, is on a right side of the front shaft 321B, and is non-coaxial with the front shaft 321B. With further reference to FIG. 12, when the embracing arm 32B is forced to rotate by the weight of the weak person to allow the rear end portion 323B of the rear shaft 322B to extend inward toward the left side of the transport apparatus, the resilient element 33B tends to rotate the embracing arm 32B reversely to allow the rear end portion 323B of the rear shaft 322B to extend downward toward the mobile chassis 10.

In the preferred embodiment of the present invention as shown in the figures, the at least one bearing seat 31A, 31B of each of the armpit supports 30A, 30B is comprised of two bearing seats 31A, 31B separately assembled on the lifting racks 24 respectively. The front shaft 321A of the embracing arm 32A is mounted through the two bearing seats 31A and is rotatable. Similarly, the front shaft 321B of the embracing arm 32B is mounted through the two bearing seats 31B and is rotatable.

Preferably, each of the armpit supports 30A, 30B is further comprised of a cushion sleeve 34A, 34B. The two cushion sleeves 34A, 34B are mounted around the rear shafts 322A, 322B and the rear end portions 323A, 323B of the two embracing arms 32A, 32B respectively.

The two seat assemblies 40 are mirror-symmetrically assembled on the mobile chassis 10, and more specially, are assembled on the distal ends of the upper extending bars 16 respectively. Each of the seat assemblies 40 is comprised of a seat plate 41 and a drive motor 42. The seat plate 41 is rotatably mounted on the distal end of a corresponding one of the upper extending bars 16, and is connected to and is driven to rotate by the drive motor 42, such as a worm drive motor, to form a seat.

With reference to FIGS. 2, 11 and 12, specifically, the seat plate 41 has a connecting portion 411 and a sitting portion 412. The connecting portion 411 is mounted on the distal end of the corresponding one of the upper extending bars 16 and connects to the drive motor 42. The sitting portion 412 is angled at about 135 degrees to the connecting portion 411.

Thus, as shown in FIG. 11, when the seat plates 41 of the two seat assemblies 40 are spun to allow the sitting portion 412 to extend upward, the weak person 51 can pass through a space between the two upper extending bars 16. As shown in FIG. 12, when the seat plates 41 of the two seat assemblies 40 are spun to be lowered, the two seat plates 41 form said seat for the weak person 51 to sit thereon.

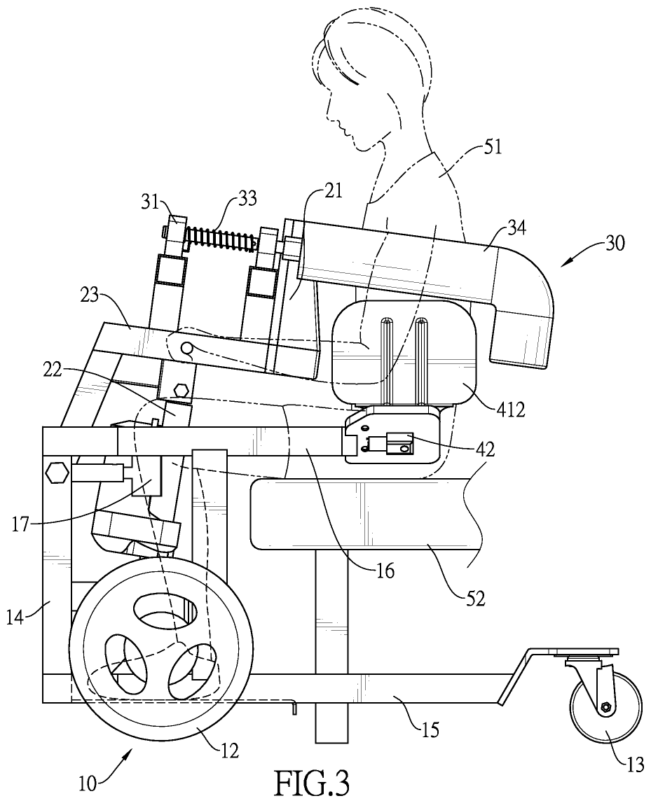

With reference to FIG. 3, the transport apparatus of the present invention can be operated by voice command or by a remote control. The weak person 51 sits on a side of the bed 52 and calls for the transport apparatus by said voice command or the remote control. The transport apparatus approaches the bed 52 with the lower extending bars 15 and the supporting wheels 13 moving into the space between the floor and the bed 52 and the two armpit supports 30 protruding beside left and right side of chest of the weak person 51. The weak person 51 raises his/her feet to step onto the deck 11 of the mobile chassis 10 and leans his/her body forward to rest his/her chest on the chest rest 21, then places both arms on the armpit support 30.

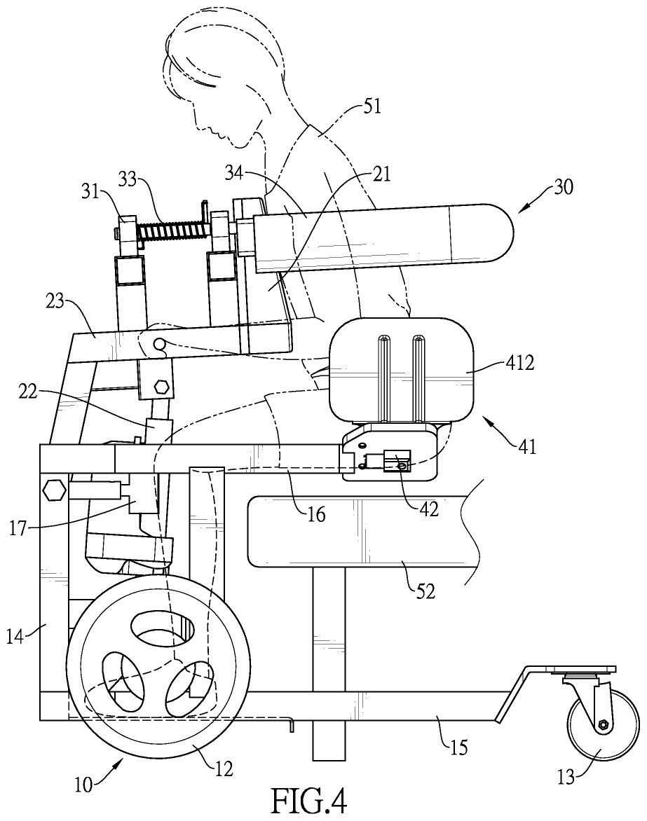

With reference to FIG. 4, as a continuation from FIG. 3, and with reference to FIGS. 8, 11 and 12, as the weak person 51 places his/her arms onto the embracing arms 32, the arms of the weak person 51 push the two embracing arms 32 to rotate inward. Accordingly, the rear end portions 323 of the rear shafts 322 of the embracing arms 32 extend transversely behind the weak person's 51 back, so as to prevent the weak person 51 to fall backward.

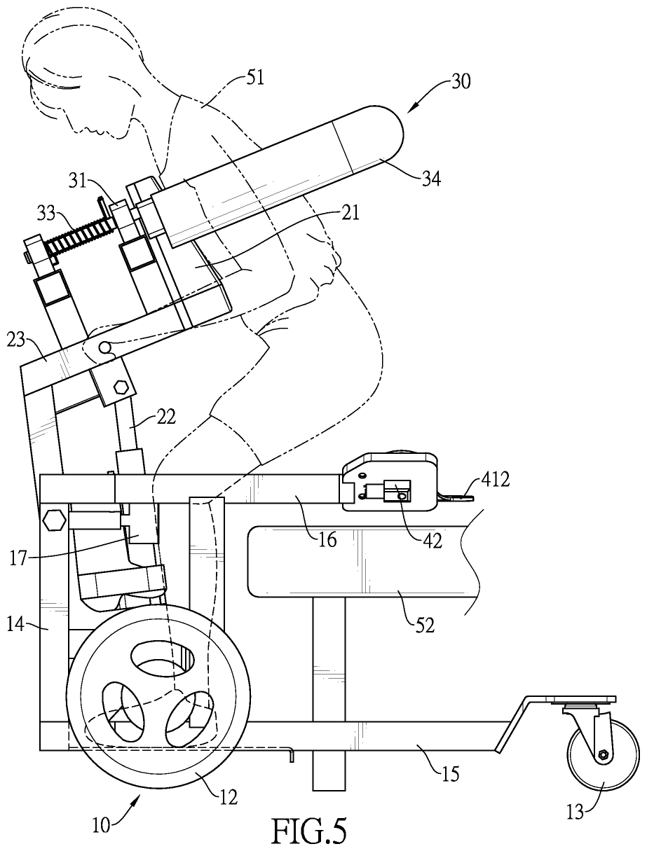

With reference to FIG. 5, as a continuation from FIG. 4, the weak person 51 may lean forward to allow his/her chest to come in contact with the chest rest 21 and hold the lifting arm 23. Then the lifting arm 23, the chest rest 21 and the armpit supports 30 are driven to pivot upward by the linear actuator 22 and move the weak person 51 away from the bed 52. Further, the two seat plates 41 are driven by the drive motors 42 to spin lowered to form the seat below the hip of the weak person 51.

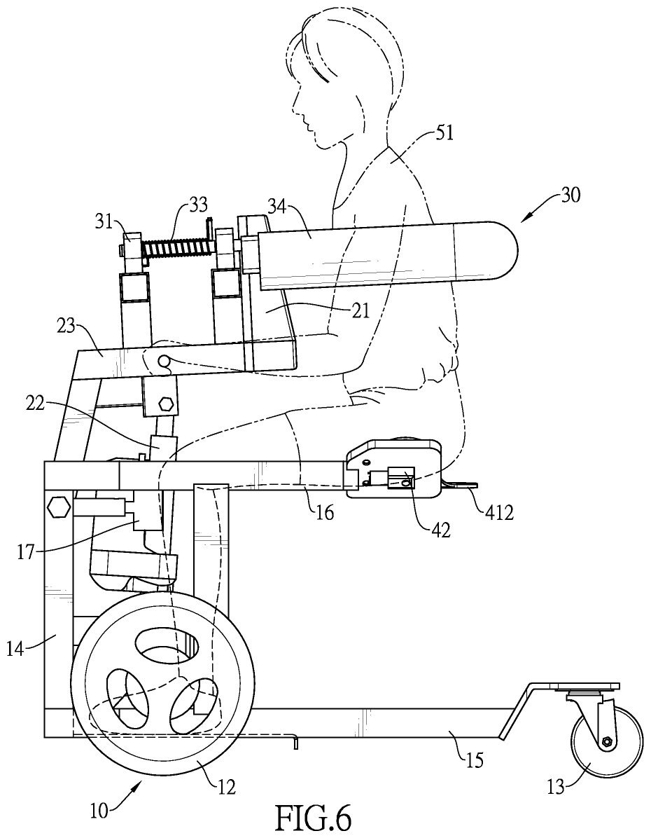

With reference to FIG. 6, as a continuation from FIG. 5, the armpit supports 30 are driven to pivot upward by the linear actuator 22 again to allow the weak person 51 to sit on the seat formed by the two seat plates 41. Then the transport apparatus can be operated to moves away from the bed 52 by the voice command or by the remote control.

The transport apparatus of the present invention is simple and compact. With the transport apparatus as described above, the weak person 51 can move the transport apparatus directly, or the transport apparatus can be operated by voice command from the weak person 51 or the care workers, or by the remote control which is under the control of the weak person 51 or the care workers. Since the weak person 51 is not moved by the care workers, the weak person 51 can be moved in an easier and safer way.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A transport apparatus for a weak person, and the transport apparatus comprised of:
a mobile chassis;
a lifting mechanism assembled on a front portion of the mobile chassis and comprised of:
a lifting arm pivotally assembled on the front portion of the mobile chassis;
a chest rest mounted on a rear end of the lifting arm; and
a linear actuator assembled to the mobile chassis and the lifting arm, and driving the chest rest to pivot upward or downward;
two armpit supports separately assembled on an upper mounting portion of the lifting arm and structured and operated mirror-symmetrical to one another, and each armpit support comprised of:
at least one bearing seat assembled on the upper mounting portion of the lifting arm; and
an embracing arm rotatably mounted through the at least one bearing seat and transversely extending toward a rear of the mobile chassis; and
two seat assemblies mirror-symmetrically assembled on the mobile chassis.

2. The transport apparatus as claimed in claim 1, wherein
the embracing arm comprised of:
a front shaft mounted through the at least one bearing seat and is rotatable; and
a rear shaft extending parallel to the front shaft and toward the rear of the mobile chassis, and being non-coaxial with the front shaft, and a rear end portion of the rear shaft being bent;
a resilient element is connected to the front shaft and the upper mounting portion of the lifting arm, such that the bent rear end portion of the rear shaft extends downward toward the mobile chassis in a natural state;
when the embracing arm is forced to rotate to allow the bent rear end portion of the rear shaft to extend inward, the resilient element rotates the embracing arm reversely to allow the rear end portion of the rear shaft to extend downward toward the mobile chassis.

3. The transport apparatus as claimed in claim 2, wherein each of the two armpit supports is further comprised of a cushion sleeve, and the two cushion sleeves are mounted around the rear shafts and the rear end portions of the two embracing arms respectively.

4. The transport apparatus as claimed in claim 2, wherein the at least one bearing seat of each of the armpit supports is comprised of two bearing seats, and the two bearing seats are separately assembled on the lifting mechanism; and the front shaft of the embracing arm is rotatably mounted through the two bearing seats.

5. The transport apparatus as claimed in claim 1, wherein
the mobile chassis is comprised of:
a deck;
a front upright frame located on and protruding up from the deck;
two lower extending bars transversely extending from the front upright frame toward the rear of the mobile chassis and being located on left and right sides of the mobile chassis respectively; and
two upper extending bars transversely extending from the front upright frame toward the rear of the mobile chassis, and being located on the left and right sides of the mobile chassis respectively and above the lower extending bars respectively; and
the two seat assemblies are assembled on two distal ends of the two upper extending bars respectively, and the seat plates of the two seat assemblies are rotatable to form a seat.

6. The transport apparatus as claimed in claim 5, wherein the mobile chassis is further comprised of two knee supports, and the knee supports are separately assembled on the front upright frame and are located between the two upper extending bars.

7. The transport apparatus as claimed in claim 1, wherein
two motorized wheels are assembled on the front portion of the mobile chassis and are located on left and right sides of the mobile chassis respectively; and
multiple supporting wheels are assembled on a rear portion of the mobile chassis.

8. The transport apparatus as claimed in claim 5, wherein
two motorized wheels are assembled on left and right sides of the front upright frame; and
multiple supporting wheels are assembled on distal ends of the lower extending bars.

9. The transport apparatus as claimed in claim 1, wherein each of the two seat assemblies is comprised of a seat plate and a drive motor, and the seat plate is connected to and driven to rotate by the drive motor to form a seat.

10. The transport apparatus as claimed in claim 5, wherein the seat plate of each seat assembly has
a connecting portion mounted on the distal end of the upper extending bars and connecting to the drive motor; and
a sitting portion being angled at 135 degrees to the connecting portion.
